(19) United States
(12) Patent Application Publication
(10) Pub. No.: US 2025/0208685 A1
(43) Pub. Date: Jun. 26, 2025

(54) INVERSE TEMPERATURE-DEPENDENT POWER CONTROL IN MULTI-CORE PROCESSOR

(71) Applicant: Intel Corporation, Santa Clara, CA (US)

(72) Inventors: Suranjan Chakraborty, Bangalore (IN); Rajesh Kumar Jena, Bangalore (IN); Anil B. Lingambudi, Bangalore (IN); Prasanna Jayaraman, Pflugerville, TX (US); Amruta Misra, Bangalore (IN)

(21) Appl. No.: 18/391,348

(22) Filed: Dec. 20, 2023

(51) Int. Cl. G06F 1/3206

(52) U.S. Cl. CPC G06F 1/3206

(57) ABSTRACT

Embodiments herein relate to techniques to select one or more processor cores, of a multi-core processor, for a workload based on a temperature associated with the processor cores. The processor circuitry may further include temperature sensors (e.g., temperature sensing diodes) arranged to generate temperature information that is associated with respective individual processor cores of the plurality of processor cores. It may be determined that one or more of the processor cores need to be woken up from a low power state to handle a workload. A control circuitry may receive the temperature information and may select a first processor core, of the plurality of processor cores, to wakeup from the low power state based on the temperature information. For example, the control circuitry may prioritize the processor core with the highest temperature according to the temperature information. Other embodiments may be described and claimed.

### BACKGROUND

Many microprocessors are designed with several computing cores and functional circuit blocks (also referred to as intellectual property (IP) blocks). According to the inverse temperature dependency (ITD) device effect, transistors slow down as temperature decreases for supply voltages below a threshold limit. Some microprocessors compensate for this ITD effect by increasing the supply voltage as a function of the temperature and minimum voltage (Vmin) of the circuit. Accordingly, the voltage is increased when the temperature is colder. Additionally, as the Vmin decreases relative to a reference voltage, the voltage vs. temperature slope increases.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 illustrates an example of processor circuitry with temperature sensing diodes, in accordance with various embodiments.

FIG. 2 illustrates example components of a device in accordance with various embodiments.

FIG. 3 illustrates an example process in accordance with various embodiments.

FIG. 4 illustrates an example of components that may be present in a computing system for implementing the techniques (e.g., operations, processes, methods, and methodologies) described herein, in accordance with various embodiments.

### DETAILED DESCRIPTION

Various embodiments herein provide techniques to select one or more processor cores for a workload based on a temperature associated with the processor cores. The techniques may be used with processor circuitry that includes multiple processor cores. The processor cores may be on a same die and/or on different dies. The processor circuitry may further include temperature sensors (e.g., temperature sensing diodes) arranged to generate temperature information that is associated with respective individual processor cores of the plurality of processor cores. In embodiments, it may be determined that one or more of the processor cores need to be woken up from a low power state to handle a workload. A control circuitry may receive the temperature information and may select a first processor core, of the plurality of processor cores, to wakeup from the low power state based on the temperature information.

In various embodiments, the control circuitry may prioritize the processor core with the highest temperature according to the temperature information. For example, the control circuitry may select the first processor core as the processor core with the highest associated temperature among the plurality of processor cores. The processor cores may use temperature-dependent operation (also referred to as inverse temperature dependency (ITD)), in which a supply voltage provided to the processor core is based on the temperature associated with the processor core. For example, the supply voltage may be increased as the associated temperature decreases (e.g., 2.5 mV increase in supply voltage per one degree Celsius decrease in temperature, in one non-limiting example). Accordingly, selection of a processor core with a higher temperature provides lower power consumption. Additionally, the processor core may be subject to one or more power limits that, when triggered, can result in changes in performance (e.g., throttling of operating frequency and/or another suitable parameter). The techniques herein may prevent or reduce the likelihood that the power limits are reached.

In some embodiments, the control circuitry may take into account other sources of power consumption, in addition to the temperature of the processor core, when selecting the first processor core for the workload. For example, the processor cores may be associated with designated sets of other circuitry in the device, such as input/output (I/O) circuitry, memory circuitry, etc. The control circuitry may estimate a power consumption of the other circuits (e.g., based on associated temperature information and/or other factors) and generate an estimate of a total power consumption associated with selecting the respective processor core. The control circuitry may select the processor core that is associated with the lowest total power consumption.

Additionally, the operation of a first processor core to handle the workload may cause an increase in the temperature of one or more adjacent processor cores. For example, testing results of one example implementation showed 31-37% thermal interference on an adjacent processor core due to the running a load on the first processor core. Accordingly, if the control circuitry determines that a second processor core is to be woken up, the control circuitry may select the second processor core based on proximity information and/or a heatmap with reference to the first processor core. The proximity information may indicate a distance of other cores with respect to one another, and/or other information that spatially links the cores to one another such as being part of a same group of cores (e.g., a core module) and/or in a same integrated circuit die (e.g., in a in a multi-core system that includes multiple dies). The heatmap may indicate an expected temperature change in other processor cores caused by the operation of the first processor core. Accordingly, if the workload requires multiple processor cores, the control circuitry may select multiple processor cores that are adjacent to one another and/or otherwise thermally coupled. Additionally, or alternatively, in some embodiments, the workload may be started on the first processor core and subsequently transferred to a second processor core with a different size and/or capabilities, e.g., if it is determined that the first processor core is not able to handle the workload. The control circuitry may select the second processor core at least in part based on the proximity information and/or heatmap.

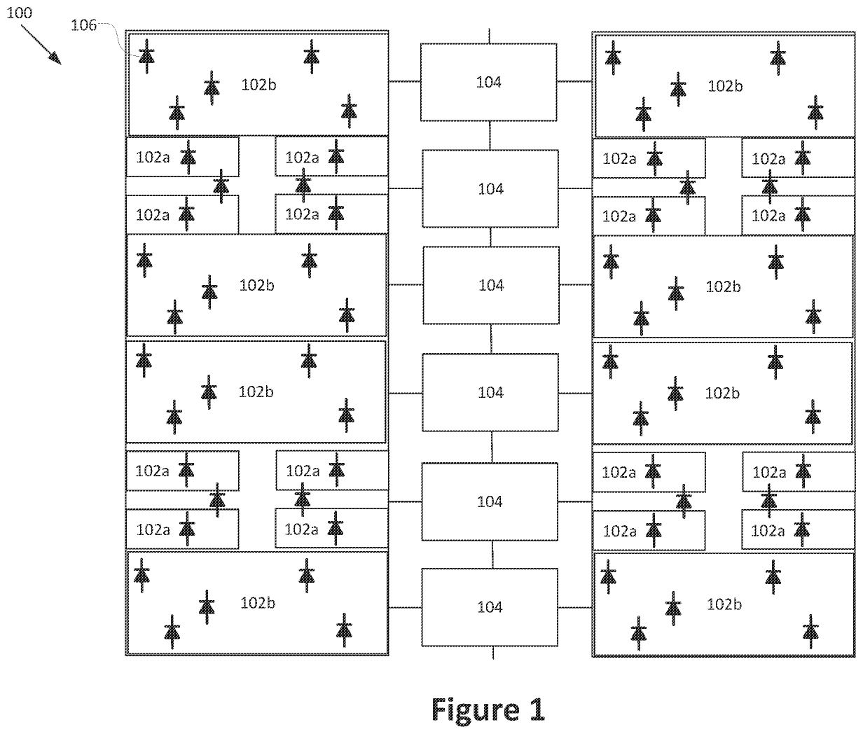

FIG. 1 illustrates an example processor circuitry 100 in accordance with various embodiments. The processor circuitry 100 includes a plurality of processor cores 102a and 102b. The processor circuitry 100 may be a hybrid processor that includes processor cores 102a-b with different characteristics. For example, the processor cores 102a may be relatively smaller and less capable than the processor cores 102b, while also providing lower power consumption. Accordingly, the processor cores 102a may be referred to herein as “energy-efficient cores” and the processor cores 102b may be referred to as “performance cores.” However, it is also noted that the techniques described herein may be used with processor circuitry that includes only processor cores of the same characteristics (e.g., homogeneous cores).

The processor circuitry 100 further includes fabric circuitry 104 coupled between the processor cores 102a-b to facilitate communication by and/or between the processor cores 102a-b. Furthermore, the processor circuitry 100 further includes a plurality of temperature sensors 106 arranged to generate temperature information that is associated with individual processor cores of the processor cores 102a-b. The temperature sensors 106 may be thermal sensor diodes and/or another suitable type of temperature sensor.

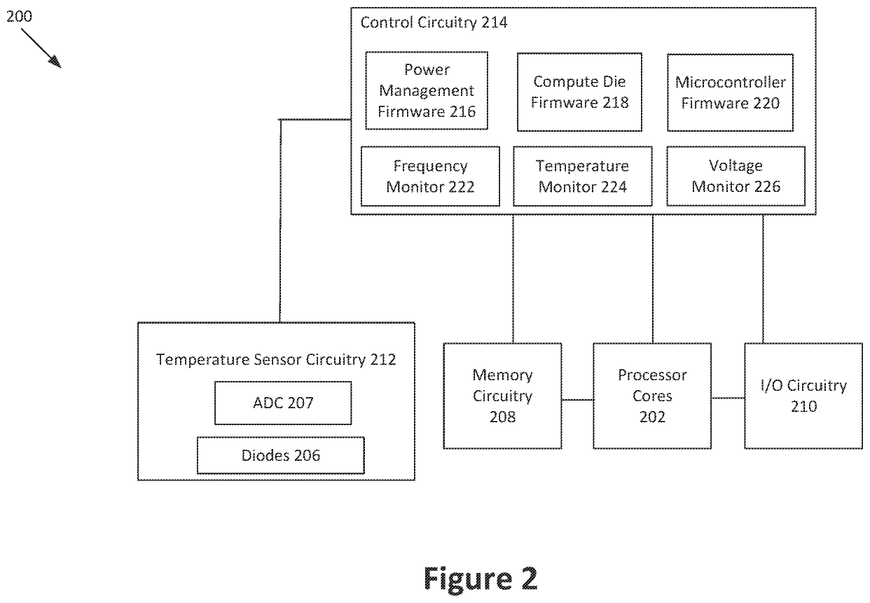

FIG. 2 illustrates an example circuitry 200 to perform temperature-dependent operation of multi-core processor circuitry, as disclosed herein. The circuitry 200 may include a plurality of processor cores 202 that may correspond to the processor cores 102a-b of FIG. 1. The circuitry 200 may further include memory circuitry 208 and I/O circuitry 210 coupled to the processor cores 202. As discussed above, the memory circuitry 208 may include multiple memory circuits and/or the I/O circuitry 210 may include multiple I/O circuits. Each memory circuit and/or I/O circuit may be associated with one or more of the processor cores 202.

The circuitry 200 may further include temperature sensor circuitry 212 and control circuitry 214. The temperature sensor circuitry 212 may include diode thermal sensors 206 (also referred to as “diodes”). The diodes 206 may be arranged within or adjacent to the processor cores 202 to generate outputs that are indicative of the temperature of the respective processor cores (e.g., as shown with respect to the diodes 106 in FIG. 1). In some embodiments, the diodes 206 may also include diodes that indicate the temperature of other components of the circuitry 200, such as memory circuits of memory circuitry 208 and/or I/O circuits of I/O circuitry 210. Although the temperature sensors are referred to as diodes herein, other types of temperature sensors may be used in accordance with various embodiments.

The temperature sensor circuitry 212 may provide the temperature information from the diodes 206 to the control circuitry 214. In some embodiments, the temperature information may be output by the diodes 206 in analog form, and the temperature sensor circuitry 212 may include one or more analog-to-digital converters (ADCs) 207 to digitize the temperature information prior to providing it to the control circuitry 214.

In embodiments, the control circuitry 214 may include components such as power management firmware 216, compute die firmware 218, and/or microcontroller firmware 220 to control power and/or operation of the processor circuitry (e.g., processor cores 202) and/or other components of circuitry 200. The techniques described herein may be implemented in any of power management firmware 216, compute die firmware 218, microcontroller firmware 220, a combination thereof, and/or other components of control circuitry 214. For example, the temperature-dependent core selection techniques described herein may be associated with a basic input/output system (BIOS) knob, which may be enabled to implement the techniques. The control circuitry 214 may further include a frequency monitor 222, a temperature monitor 224, and/or a voltage monitor 226 to monitor and/or control the frequency, temperature, and/or voltage, respectively, of the processor circuitry and/or other components of circuitry 200. The control circuitry 214 may receive the temperature information from the temperature sensor circuitry 212, and may determine a temperature associated with each of the processor cores based on the temperature information.

The processor cores 202 may be placed in a low power state under certain conditions, e.g., when not processing a task. In various embodiments, the control circuitry 214 may identify that one or more of the processor cores 202 need to be woken up from the low power state (e.g., transitioned to a higher power state) to process a workload (which may include one or more tasks). For example, one or more tasks may be scheduled by an operating system (OS) task scheduler. The control circuitry 214 may select a first processor core, of the plurality of processor cores 202, to be woken up based on the temperature information. For example, the control circuitry 214 may select the first processor core to have the highest associated temperature from among the plurality of processor cores 202. The control circuitry 214 may then wakeup the selected first processor core to handle the workload.

In embodiments, the first processor core may be woken up using ITD control in which the supply voltage provided to the first processor core is dependent on the temperature associated with the first processor core and an associated minimum voltage, Vmin. The operating frequency of the transistors and/or other circuitry may generally decrease as temperature drops. Accordingly, the supply voltage may be greater for a lower temperature in order to maintain the same frequency. Additionally, as the Vmin decreases relative to a reference voltage, the slope of the voltage vs. temperature change increases. In some embodiments, the ITD control may be triggered when the temperature of the processor core is less than a threshold. The supply voltage may not be varied based on temperature when the temperature is above the threshold (although there may be an upper temperature limit that results in throttling and/or another action).

Many integrated circuits can experience significant and fast temperature changes. In one non-limiting example, an integrated circuit may experience a temperature change of 20 degrees Celsius within 1 millisecond. If the temperature-dependent control adds a 2.5 millivolt (mV) increment in supply voltage per degree Celsius in temperature change, a change of 20 degrees Celsius results in a 50 mV increase in supply voltage. Furthermore, the temperature-dependent control functionality may also add a 100 mV guard band voltage when it is triggered, thus adding an additional 100 mV to the supply voltage for a total change of 150 mV. Accordingly, selecting the processor core for wakeup that has the highest temperature may provide significantly lower power consumption compared with waking up one of the other processor cores.

In some embodiments, the control circuitry 214 may select the first processor core for wakeup based further on an estimated power consumption of one or more other circuits, such as a memory circuit and/or I/O circuit associated with the respective processor core. The estimated power consumption of the one or more other circuits may be based on temperature information associated with the respective circuits and/or other parameters such as differences in the size or other characteristics of the respective circuits. In some embodiments, the control circuitry 214 may select the first processor core as having a lowest total power consumption associated with wakeup (e.g., based on the temperature of the respective processor core and the estimated power consumption of the one or more other circuits associated with the respective processor core).

In various embodiments, the control circuitry 214 may identify that another processor core needs to be woken up from the low power state, e.g., to process the same workload or a different workload as the first processor core. For example, the workload may require multiple processor cores to process, and/or the control circuitry 214 may identify that the workload to be transferred to another processor core that has different performance characteristics than the first processor core (e.g., to a performance core 102b instead of an energy-efficient core 102a as shown in FIG. 1). Accordingly, the control circuitry 214 may select a second processor core to be woken up. In some embodiments, the second processor core may be selected at least in part based on proximity information with respect to the first processor core. The proximity information may refer to a physical distance between the cores and/or other characteristics that link the cores to one another such as being part of a same group of cores (e.g., a core module) and/or in a same integrated circuit die (e.g., in a in a multi-core system that includes multiple dies).

The wakeup and operation of the first processor core in a higher power state may cause the temperature of nearby processor cores to rise more than processor cores that are farther away. Accordingly, selecting the second processor core that is closest to the first processor core and/or otherwise linked to the first processor core (e.g., according to the proximity information) may enable a lower supply voltage to be used according to the temperature-dependent supply voltage.

For example, the control circuitry 214 store or otherwise have access to distance data that indicates a distance between respective processor cores. Table 1 illustrates one example of distance data that indicates distances between pairs of processor cores from among four modules (e.g., IP0, IP1, IP2, and IP3) that each include 4 processor cores (e.g., IP00, IP01, IP02, and IP03 of module IP0).

TABLE 1

| | | IP0 | | | | | |
|---|---|---|---|---|---|---|---|
| | | IP00 | IP01 | IP02 | IP03 | | |
| IP1 | IP10 | Distance | Distance | Distance | Distance | IP20 | IP2 |
| | | (0, 0) | (0, 1) | (0, 2) | (0, 3) | | |
| | IP11 | Distance | Distance | Distance | Distance | IP21 | |
| | | (1, 0) | (1, 1) | (1, 2) | (1, 3) | | |
| | IP12 | Distance | Distance | Distance | Distance | IP22 | |
| | | (2, 0) | (2, 1) | (2, 2) | (2, 3) | | |
| | IP13 | Distance | Distance | Distance | Distance | IP23 | |
| | | (3, 0) | (3, 1) | (3, 2) | (3, 3) | | |
| | | IP30 | IP31 | IP32 | IP33 | | |

IP3

Additionally, or alternatively, the control circuitry 214 may select the second processor core based on characterization information that indicates a temperature dependency of other processor cores linked to the operation of the first processor core in the higher power state. For example, the characterization information may correspond to a heatmap that indicates a rise in temperature for respective processor cores caused by the operation of the first processor core. The characterization information may be predefined for a given integrated circuit layout (e.g., based on manufacturer test results and/or simulations) and/or generated by the control circuitry 214 during operation (e.g., using the temperature sensor circuitry 212).

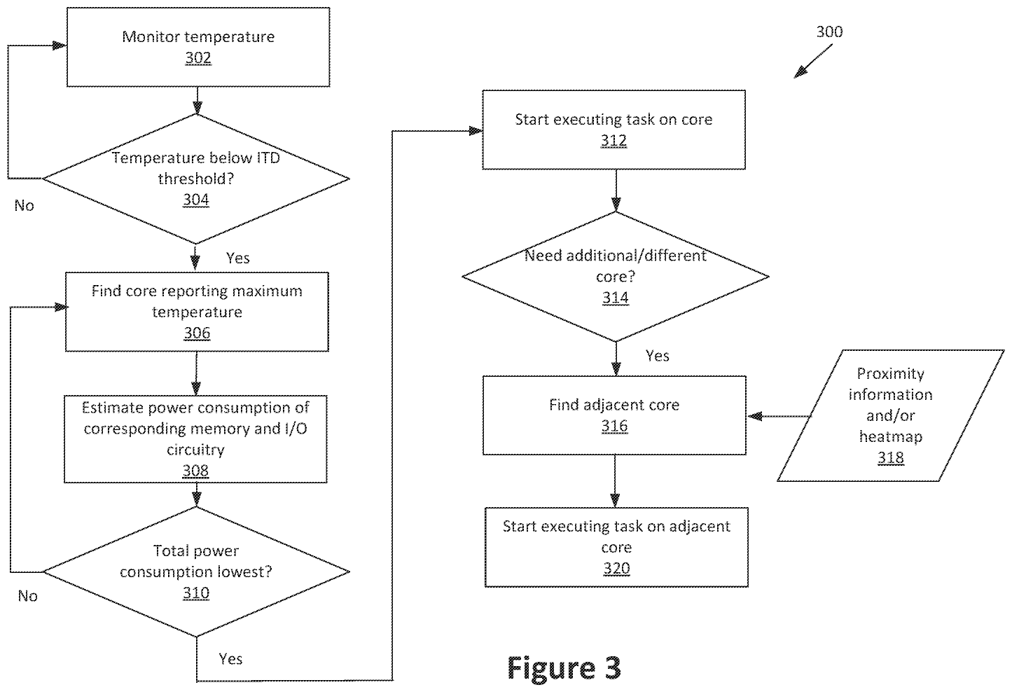

FIG. 3 illustrates an example process 300 in accordance with various embodiments herein. The process 300 may be performed by control circuitry 214 in some embodiments.

At 302, the process 300 may include to monitor temperature information associated with a plurality of processor cores (e.g., on one or more integrated circuits). At 304, the process may include to determine whether a temperature is below an ITD threshold. If not, the temperature-dependent control may not be triggered and the process 300 may include to continue to monitor the temperature information at 302. If the temperature is below the ITD threshold, then the temperature-dependent control is triggered and the process continues to block 306.

At 306, the process 300 may include to find the processor core that is associated with a maximum temperature. For example, the temperature of individual processor cores may be determined based on data from respective temperature sensors, such as diode temperature sensors.

In some embodiments, at 308, the process 300 may include to estimate a power consumption of corresponding memory and I/O circuitry associated with the processor core identified at block 306 (referred to as the first processor core). A total power consumption associated with waking up the first processor core may be determined based on the temperature of the first processor core and the estimated power consumption of the corresponding memory and I/O circuitry.

At 310, the process 300 may include to determine whether the total power consumption associated with the first processor core is the lowest among available processor cores. If so, then the first processor core may be selected to be woken up. If not, the process 300 may select a different processor core to be woken up (e.g., the processor core that has the lowest associated total power consumption). Note that, in other embodiments, block 308 may be omitted and the process 300 may select the processor core with the highest associated temperature, without taking into account other associated circuitry such as the corresponding memory and I/O circuitry.

At 312, the process 300 may include to start executing the task on the processor core selected at block 310 (e.g., the first processor core).

In some embodiments, the process 300 may continue to block 314, in which it is determined whether there is a need for an additional and/or different core (e.g., for a different task and/or the same task). If so, at block 316, the process 300 may include to identify an adjacent core to wake up based on proximity information and/or a heatmap (e.g., received at 318) as described herein. At 320, the process 300 may further include to start executing the task or another task on the identified processor core (referred to as the second processor core). For example, the second processor core may be the closest processor core to the first processor core according to the distance data and/or the processor core with the highest thermal coupling with the first processor core based on the heatmap. If the multi-core processor includes processor cores of different capabilities, then the process may select the closest processor core and/or the processor core with the highest thermal coupling that also meets the capability requirements for the task.

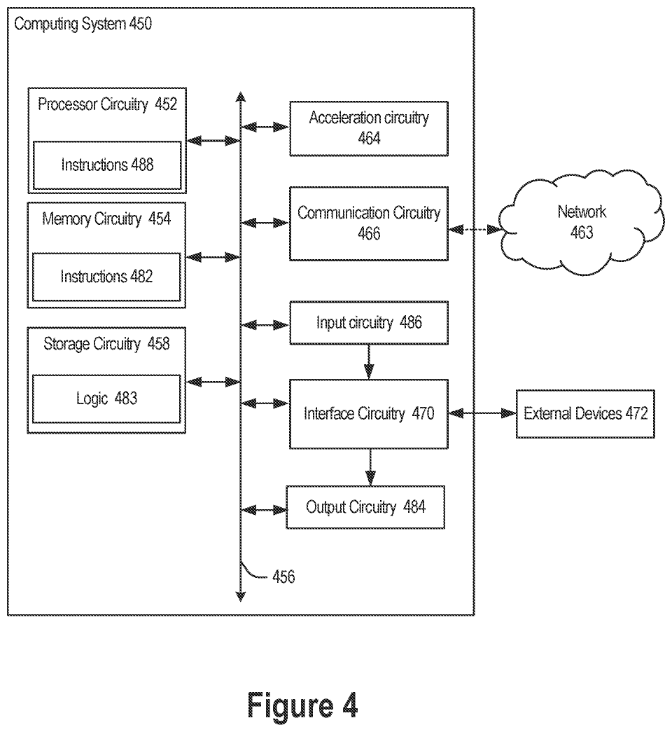

FIG. 4 illustrates an example of components that may be present in a computing system 450 for implementing the techniques (e.g., operations, processes, methods, and methodologies) described herein, in accordance with various embodiments. For example, the memory circuitry 454 may store instructions and the processor circuitry 452 may execute the instructions to perform the functions described herein.

The computing system 450 may include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 450, or as components otherwise incorporated within a chassis of a larger system. For one embodiment, at least one processor 452 may be packaged together with computational logic 482 and configured to practice aspects of various example embodiments described herein to form a System in Package (SiP) or a System on Chip (SoC).

The system 450 includes processor circuitry in the form of one or more processors 452. The processor circuitry 452 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 452 may include one or more hardware accelerators (e.g., same or similar to acceleration circuitry 464), which may be microprocessors, programmable processing devices (e.g., FPGA, ASIC, etc.), or the like. The one or more accelerators may include, for example, computer vision and/or deep learning accelerators. In some implementations, the processor circuitry 452 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein

The processor circuitry 452 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low-voltage processor, an embedded processor, or any other known processing elements, or any suitable combination thereof. The processors (or cores) 452 may be coupled with or may include memory/storage and may be configured to execute instructions stored in the memory/storage to enable various applications or operating systems to run on the platform 450. The processors (or cores) 452 is configured to operate application software to provide a specific service to a user of the platform 450. In some embodiments, the processor(s) 452 may be a special-purpose processor(s)/controller(s) configured (or configurable) to operate according to the various embodiments herein.

As examples, the processor(s) 452 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 452 may be a part of a system on a chip (SoC), System-in-Package (SiP), a multi-chip package (MCP), and/or the like, in which the processor(s) 452 and other components are formed into a single integrated circuit, or a single package, such as the Edison™ or Galileo™ SoC boards from Intel® Corporation. Other examples of the processor(s) 452 are mentioned elsewhere in the present disclosure.

The system 450 may include or be coupled to acceleration circuitry 464, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 464 may comprise logic blocks or logic fabric and other interconnected resources that may be programmed (configured) to perform various functions, such as the procedures, methods, functions, etc. of the various embodiments discussed herein. In such implementations, the acceleration circuitry 464 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 452 and/or acceleration circuitry 464 may include hardware elements specifically tailored for machine learning and/or artificial intelligence (AI) functionality. In these implementations, the processor circuitry 452 and/or acceleration circuitry 464 may be, or may include, an AI engine chip that can run many different kinds of AI instruction sets once loaded with the appropriate weightings and training code. Additionally or alternatively, the processor circuitry 452 and/or acceleration circuitry 464 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPS™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 452 and/or acceleration circuitry 464 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® Bionic SoC, the Neural Processing Unit (NPU) within the HiSilicon Kirin 970 provided by Huawei®, and/or the like. In some hardware-based implementations, individual subsystems of system 450 may be operated by the respective AI accelerating co-processor(s), AI GPUs, TPUs, or hardware accelerators (e.g., FPGAs, ASICS, DSPs, SoCs, etc.), etc., that are configured with appropriate logic blocks, bit stream(s), etc. to perform their respective functions.

The system 450 also includes system memory 454. Any number of memory devices may be used to provide for a given amount of system memory. As examples, the memory 454 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 454 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 454 is controlled by a memory controller. The individual memory devices may be of any number of different package types such as single die package (SDP), dual die package (DDP) or quad die package (Q17P). Any number of other memory implementations may be used, such as dual inline memory modules (DIMMs) of different varieties including but not limited to microDIMMs or MiniDIMMs.

Storage circuitry 458 provides persistent storage of information such as data, applications, operating systems and so forth. In an example, the storage 458 may be implemented via a solid-state disk drive (SSDD) and/or high-speed electrically erasable memory (commonly referred to as “flash memory”). Other devices that may be used for the storage 458 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 454 and/or storage circuitry 458 may also incorporate three-dimensional (3D) cross-point (XPOINT) memories from Intel® and Micron®.

The memory circuitry 454 and/or storage circuitry 458 is/are configured to store computational logic 483 in the form of software, firmware, microcode, or hardware-level instructions to implement the techniques described herein. The computational logic 483 may be employed to store working copies and/or permanent copies of programming instructions, or data to create the programming instructions, for the operation of various components of system 450 (e.g., drivers, libraries, application programming interfaces (APIs), etc.), an operating system of system 450, one or more applications, and/or for carrying out the embodiments discussed herein. The computational logic 483 may be stored or loaded into memory circuitry 454 as instructions 482, or data to create the instructions 482, which are then accessed for execution by the processor circuitry 452 to carry out the functions described herein. The processor circuitry 452 and/or the acceleration circuitry 464 accesses the memory circuitry 454 and/or the storage circuitry 458 over the interconnect (IX) 456. The instructions 482 direct the processor circuitry 452 to perform a specific sequence or flow of actions, for example, as described with respect to flowchart(s) and block diagram(s) of operations and functionality depicted previously. The various elements may be implemented by assembler instructions supported by processor circuitry 452 or high-level languages that may be compiled into instructions 488, or data to create the instructions 488, to be executed by the processor circuitry 452. The permanent copy of the programming instructions may be placed into persistent storage devices of storage circuitry 458 in the factory or in the field through, for example, a distribution medium (not shown), through a communication interface (e.g., from a distribution server (not shown)), over-the-air (OTA), or any combination thereof.

The IX 456 couples the processor 452 to communication circuitry 466 for communications with other devices, such as a remote server (not shown) and the like. The communication circuitry 466 is a hardware element, or collection of hardware elements, used to communicate over one or more networks 463 and/or with other devices. In one example, communication circuitry 466 is, or includes, transceiver circuitry configured to enable wireless communications using any number of frequencies and protocols such as, for example, the Institute of Electrical and Electronics Engineers (IEEE) 802.11 (and/or variants thereof), IEEE 802.23.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 466 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 456 also couples the processor 452 to interface circuitry 470 that is used to connect system 450 with one or more external devices 472. The external devices 472 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 450, which are referred to as input circuitry 486 and output circuitry 484. The input circuitry 486 and output circuitry 484 include one or more user interfaces designed to enable user interaction with the platform 450 and/or peripheral component interfaces designed to enable peripheral component interaction with the platform 450. Input circuitry 486 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 484 may be included to show information or otherwise convey information, such as sensor readings, actuator position(s), or other like information. Data and/or graphics may be displayed on one or more user interface components of the output circuitry 484. Output circuitry 484 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Crystal Displays (LCD), LED displays, quantum dot displays, projectors, etc.), with the output of characters, graphics, multimedia objects, and the like being generated or produced from the operation of the platform 450. The output circuitry 484 may also include speakers and/or other audio emitting devices, printer(s), and/or the like. Additionally or alternatively, sensor(s) may be used as the input circuitry 484 (e.g., an image capture device, motion capture device, or the like) and one or more actuators may be used as the output device circuitry 484 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of an edge computing system; to manage components or services of an edge computing system; identify a state of an edge computing component or service; or to conduct any other number of management or administration functions or service use cases.

The components of the system 450 may communicate over the IX 456. The IX 456 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 456 may be a proprietary bus, for example, used in a SoC based system.

The number, capability, and/or capacity of the elements of system 450 may vary, depending on whether computing system 450 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 450 may comprise one or more components of a data center, a desktop computer, a workstation, a laptop, a smartphone, a tablet, a digital camera, a smart appliance, a smart home hub, a network appliance, and/or any other device/system that processes data.

The techniques described herein can be performed partially or wholly by software or other instructions provided in a machine-readable storage medium (e.g., memory). The software is stored as processor-executable instructions (e.g., instructions to implement any other processes discussed herein). Instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions.

The storage medium can be a tangible, non-transitory machine readable medium such as read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs)), among others.

The storage medium may be included, e.g., in a communication device, a computing device, a network device, a personal digital assistant, a manufacturing tool, a mobile communication device, a cellular phone, a notebook computer, a tablet, a game console, a set top box, an embedded system, a TV (television), or a personal desktop computer.

### EXAMPLES

Some non-limiting examples of various embodiments are provided below.

Example 1 is an apparatus comprising: a plurality of processor cores; and control circuitry coupled to the plurality of processor cores. The control circuitry is to: receive temperature information associated with individual processor cores of the plurality of processor cores; select, based on the temperature information, a first processor core, of the plurality of processor cores, to wake up from a low power state to handle a workload; and wake up the selected first processor core.

Example 2 is the apparatus of example 1, wherein the control circuitry is to select the first processor core to have a highest associated temperature from among the plurality of processor cores.

Example 3 is the apparatus of example 1, wherein control circuitry is to select the first processor core based further on an estimated power consumption of at least one of a memory circuitry or an input-output circuitry associated with the first processor core.

Example 4 is the apparatus of example 3, wherein the first processor core is selected to have a lowest total estimated power consumption among the plurality of processor cores based on a temperature of the first processor core and the estimated power consumption of the memory circuitry or the input-output circuitry.

Example 5 is the apparatus of any of examples 1-4, wherein the control circuitry is further to: identify that another processor core of the plurality of processor cores needs to be woken up from the low power state; and select a second processor core, of the plurality of processor cores, to wake up based on a proximity between the second processor core and the first processor core.

Example 6 is the apparatus of example 5, wherein the second processor core has a greater workload capability than the first processor core.

Example 7 is the apparatus of any of examples 1-6, wherein the first processor core is selected based further on a heatmap that characterizes temperature dependency between the plurality of processor cores.

Example 8 is the apparatus of any of examples 1-7, wherein, to wake up the first processor core, the control circuitry is to supply a voltage to the first processor core that is dependent on a temperature associated with the first processor core.

Example 9 is the apparatus of any of examples 1-8, wherein the processor cores include two or more processor cores on a same integrated circuit die.

Example 10 is one or more non-transitory computer-readable media (NTCRM) having instructions, stored thereon, that when executed configure a device to: receive an indication that at least one processor core, of a plurality of processor cores, needs to be woken up from a low power state to process a workload; receive temperature information associated with individual processor cores of the plurality of processor cores; estimate, based on the temperature information, a power consumption of the respective individual processor cores to process the workload; and select a first processor core to process the workload, wherein the first processor core has the lowest estimated power consumption among the plurality of processor cores.

Example 11 is the one or more NTCRM of example 10, wherein the instructions, when executed, further configure the device to determine a value of a supply voltage to be provided to the first processor core based on a temperature associated with the first processor core.

Example 12 is the one or more NTCRM of example 10 or 11, wherein the first processor core has a highest associated temperature among the plurality of processor cores.

Example 13 is the one or more NTCRM of any of examples 10-12, wherein the estimated power consumption includes an estimated power consumption of at least one of a memory circuitry or an input-output circuitry associated with the respective individual processor cores.

Example 14 is the one or more NTCRM of any of examples 10-13, wherein the instructions, when executed, further configure the device to select a second processor core, of the plurality of processor cores, to wakeup based on a proximity between the second processor core and the first processor core.

Example 15 is the one or more NTCRM of any of examples 10-14, wherein the instructions, when executed, further configure the device to select a second processor core, of the plurality of processor cores, to wake up based on a heatmap that characterizes temperature dependency between the plurality of processor cores.

Example 16 is a system comprising: a power interface to provide a power supply; processor circuitry; and control circuitry coupled to the power interface and the processor circuitry. The processor circuitry includes: a plurality of processor cores; and a plurality of temperature sensors to output temperature data associated with respective individual processor cores of the plurality of processor cores. The control circuitry is to: receive the temperature data from the plurality of temperature sensors; select a first processor core, of the plurality of processor cores, to process a workload based on the temperature data; and determine a value of a supply voltage to be provided to the first processor core based on the temperature data associated with the first processor core.

Example 17 is the system of example 16, wherein the first processor core is selected to prioritize a higher associated temperature.

Example 18 is the system of example 16, wherein the first processor core is selected further based on an estimated power consumption of at least one of a memory circuitry or an input-output circuitry associated with the first processor core.

Example 19 is the system of any of examples 16-18, wherein the control circuitry is further to select a second processor core, of the plurality of processor cores, to process the workload or another workload based on: a proximity between the second processor core and the first processor core; or a heatmap that characterizes temperature dependency between the plurality of processor cores.

Example 20 is the system of any of examples 16-19, further comprising at least one of: a battery coupled to the power interface; or a display coupled to the processor circuitry.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus comprising:
a plurality of processor cores; and
control circuitry coupled to the plurality of processor cores, the control circuitry to:
receive temperature information associated with individual processor cores of the plurality of processor cores;
select, based on the temperature information, a first processor core, of the plurality of processor cores, to wake up from a low power state to handle a workload; and
wake up the selected first processor core.

2. The apparatus of claim 1, wherein the control circuitry is to select the first processor core to have a highest associated temperature from among the plurality of processor cores.

3. The apparatus of claim 1, wherein the control circuitry is to select the first processor core based further on an estimated power consumption of at least one of a memory circuitry or an input-output circuitry associated with the first processor core.

4. The apparatus of claim 3, wherein the first processor core is selected to have a lowest total estimated power consumption among the plurality of processor cores based on a temperature of the first processor core and the estimated power consumption of the memory circuitry or the input-output circuitry.

5. The apparatus of claim 1, wherein the control circuitry is further to:
identify that another processor core of the plurality of processor cores needs to be woken up from the low power state; and
select a second processor core, of the plurality of processor cores, to wake up based on a proximity between the second processor core and the first processor core.

6. The apparatus of claim 5, wherein the second processor core has a greater workload capability than the first processor core.

7. The apparatus of claim 1, wherein the first processor core is selected based further on a heatmap that characterizes temperature dependency between the plurality of processor cores.

8. The apparatus of claim 1, wherein, to wake up the first processor core, the control circuitry is to supply a voltage to the first processor core that is dependent on a temperature associated with the first processor core.

9. The apparatus of claim 1, wherein the processor cores include two or more processor cores on a same integrated circuit die.

10. One or more non-transitory computer-readable media (NTCRM) having instructions, stored thereon, that when executed configure a device to:
receive an indication that at least one processor core, of a plurality of processor cores, needs to be woken up from a low power state to process a workload;
receive temperature information associated with individual processor cores of the plurality of processor cores;
estimate, based on the temperature information, a power consumption of the respective individual processor cores to process the workload; and
select a first processor core to process the workload, wherein the first processor core has the lowest estimated power consumption among the plurality of processor cores.

11. The one or more NTCRM of claim 10, wherein the instructions, when executed, further configure the device to determine a value of a supply voltage to be provided to the first processor core based on a temperature associated with the first processor core.

12. The one or more NTCRM of claim 10, wherein the first processor core has a highest associated temperature among the plurality of processor cores.

13. The one or more NTCRM of claim 10, wherein the estimated power consumption includes an estimated power consumption of at least one of a memory circuitry or an input-output circuitry associated with the respective individual processor cores.

14. The one or more NTCRM of claim 10, wherein the instructions, when executed, further configure the device to select a second processor core, of the plurality of processor cores, to wakeup based on a proximity between the second processor core and the first processor core.

15. The one or more NTCRM of claim 10, wherein the instructions, when executed, further configure the device to select a second processor core, of the plurality of processor cores, to wake up based on a heatmap that characterizes temperature dependency between the plurality of processor cores.

16. A system comprising:
a power interface to provide a power supply;
processor circuitry that includes:
a plurality of processor cores; and
a plurality of temperature sensors to output temperature data associated with respective individual processor cores of the plurality of processor cores; and
control circuitry coupled to the power interface and the processor circuitry, the control circuitry to:
receive the temperature data from the plurality of temperature sensors;
select a first processor core, of the plurality of processor cores, to process a workload based on the temperature data; and
determine a value of a supply voltage to be provided to the first processor core based on the temperature data associated with the first processor core.

17. The system of claim 16, wherein the first processor core is selected to prioritize a higher associated temperature.

18. The system of claim 16, wherein the first processor core is selected further based on an estimated power consumption of at least one of a memory circuitry or an input-output circuitry associated with the first processor core.

19. The system of claim 16, wherein the control circuitry is further to select a second processor core, of the plurality of processor cores, to process the workload or another workload based on:
a proximity between the second processor core and the first processor core; or
a heatmap that characterizes temperature dependency between the plurality of processor cores.

20. The system of claim 16, further comprising at least one of:
a battery coupled to the power interface; or
a display coupled to the processor circuitry.
